(19) United States
(12) Patent Application Publication
(10) Pub. No.: US 2010/0031883 A1
(43) Pub. Date: Feb. 11, 2010

(54) CONDUCTIVE PATTERN FORMING APPARATUS

(76) Inventors: Yuichiro Sano, Mito (JP); Toru Miyasaka, Hitachinake (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/722,901

(22) PCT Filed: Jan. 25, 2006
(86) PCT No.: PCT/JP2006/001128

§ 371 Date: Jun. 27, 2007

(30) Foreign Application Priority Data
Mar. 30, 2005 (JP) 205-096673

(51) Int. Cl. B05B 5/025

(52) U.S. Cl. 118/621

(57) ABSTRACT

A conductive pattern forming apparatus using electrostatic force, by which high productivity, application to a large area and pattern change availability are achieved, without limiting a substrate nor increasing extra steps of plating and the like, with easy steps, lower cost, shorter manufacturing time and less environmental load. The conductive pattern forming apparatus is provided with an electrostatic latent image forming means for forming an electrostatic pattern on a dielectric thin film surface, and a developing means for forming the conductive pattern by development by supplying a conductive particle dispersed solution to the electrostatic latent image and bringing the solution into contact with the electrostatic latent image. The conductive particle dispersed solution is provided by dispersing conductive particles, which have ionic organic molecules adsorbed on the surface and a particle diameter of 100 nm or less, in a non-polar solvent.

### TECHNICAL FIELD

The present invention relates to a forming apparatus for forming a conductive pattern on a printed substrate.

### BACKGROUND ART

Heretofore, as a method of forming an optional conductive pattern on a circuit substrate or the like, a method of combining a lithographic technique, an etching technique and a plating technique has been general. However, the method requires a mask for exposure that takes a lot of time for the design and preparation and also requires a high level fabrication technique. Further, since a series of steps has been complicated, it needs a long time for manufacturing and is costly. Accordingly, in the case where modification is necessary for the mask such as production of multiple types of products in a small amount, this result in an increase in the cost or delivery delay. In addition, since the use of a great amount of environmentally noxious substances such as resist or etching solution is indispensable, control and disposal for wastes have been costly.

In view of the above, as a method for forming a conductive pattern, which has simple steps, it has been proposed a screen printing method of using a conductive paste formed by dispersing conductive particles, binder resins or the like in a solvent and passing the same through a printed mesh thereby forming a pattern, and a direct drawing method of forming a pattern directly on a substrate using a conductive paste by nozzle scanning such as a dispenser or ink jet technique.

However, in the screen printing method, since the print making for a printing screen which is essential for the pattern formation can not be said simple and convenient, a great amount of screen print making is necessary for production of multiple types of products in a small quantity which modification of a pattern is required a lot. This results in an increase in time required for the print making and increase in the cost. Further, since the screens result in wastes, the cost for the control and the disposal thereof also results in a problem. On the other hand, since the direct drawing system such as the dispenser or the ink jetting also draws a pattern of an inorganic material directly on a substrate by nozzle scanning, this results in a problem of making the printing time extremely longer and not capable of coping with the mass production or formation of large area pattern and this has not yet been put to practical use.

Accordingly, as a novel method of forming a conductive pattern, it has been noted in recent years a method of using a toner with internal addition of conductive metal particles in a resin and forming a desired conductive pattern on an insulative substrate by utilizing an electrostatic force (see, for example, Patent Document 1). Since this is a system similar to printing, it can not only cope with mass production or formation of large area pattern but also can easily change the conductive pattern, it is optimal also to production in a small quantity and for various kinds.

However, in the method, since conductive metal particles as the conductive material are used being added internally in the toner, an insulative resin ingredient is present as a toner binder between conductive metal particles, and a resistance value required for usual circuit substrates could not be attained.

As a countermeasure for the subject described above, for example, Patent Document 1 discloses a method of using a ceramic green sheet as a substrate and removing a binder resin by firing at high temperature. Further, for example, Patent Document 2 discloses a method of forming wirings with conductive metal particles as plating nuclei.

Patent Document 1: JP-A No. 2004-184598

Patent Document 2: JP-A No. 2004-48030

### DISCLOSURE OF THE INVENTION

### Problem to be Solved by the Invention

In the method of Patent Document 1, since a resistance value sufficient for a wiring circuit cannot be obtained, and the substrate is restricted to a substrate of high heat resistance such as ceramics, it can not be applied to a resin substrate of low heat resistance such as of an epoxy resin.

Further, in the method of Patent Document 2, steps for the removal of the resin layer, plating, etc. are essential resulting in a problem of increasing the preparation time and cost.

The present invention has been achieved for attaining a conductive pattern forming apparatus by a new method capable of dissolving such a problem and it is an object thereof to provide a conductive pattern forming apparatus utilizing an electrostatic force, without restriction on substrates and without increase in additional steps such as plating, with simple and convenient steps, with less cost, manufacturing time, and environmental load, having high productivity, and capable of coping with large area and easy modification of the pattern.

### Means for Solving the Problem

To attain the foregoing object, the present invention provides a conductive pattern forming apparatus including static latent image forming means of forming a static pattern on the surface of a dielectric thin film, and developing means of supplying a conductive particle dispersion solution so as to contact the solution with the static latent image thereby developing and forming a conductive pattern. The conductive particle dispersion solution is formed by dispersing conductive particles having a grain size of 100 nm or less and having ionic organic molecules adsorbed on their surfaces in a non-polar solvent.

### EFFECT OF THE INVENTION

According to the conductive pattern forming apparatus of the invention, it is possible to realize a conductive pattern forming apparatus, without restriction on substrates and increase in additional steps such as plating, with simple and convenient steps, with less cost, manufacturing time and environmental load, at high productivity, and capable of coping with a large area and easily modifying the pattern.

### BEST MODE FOR CARRYING OUT THE INVENTION

Embodiments of the present invention will be described in detail below.

### First Embodiment

FIG. 1 schematically shows an example of a conductive pattern forming apparatus according to the present invention. The apparatus mainly comprises: a charging device 1 for uniformly charging the surface of a dielectric thin film 4 forming a drum-shape photoreceptor; an exposure device 3 for irradiating light to the surface of the uniformly charged dielectric thin film 4 thereby forming a static latent image; a developing device 6 having therein a conductive particle dispersion solution 7 for depositing conductive particles to the static latent image to develop the same; a transfer device 9 for transferring the developed image to a substrate 8; and a heating device 13 for heating to melt the image on the substrate 8 and fixing the same to the substrate 8.

As the static latent image forming means of the present invention, those having light sensitivity are used as the dielectric thin film 4. Further, as the charging device 1 for uniformly charging the surface of the dielectric thin film 4, one of corotron charge, roller contact charge, brush contact charge and the like is used. The surface of the dielectric thin film 4 is made into a uniformly charged state 2 by the charging device 1. Then, light is irradiated to an optional portion on the surface of the dielectric thin film 4 by the exposure device 3 for scanning laser light in accordance with image signals from image information processing apparatus such as a personal computer thereby forming an aimed static latent image 5. There is also a method of forming the aimed static latent image 5 by a stamp charging without using the charging device 1 and the exposure device 3 by the laser light but applying a static charge to a convex portion of a static latent image transfer body previously fabricated at the surface to an aimed pattern shape and bringing the same into contact with the surface of the dielectric thin film 1. However, since a die is used in the stamp charge, it has a drawback that the static latent image to be formed cannot be changed easily. To attain easy change of the static latent image 5, the former forming method of the static latent image pattern 5 by exposure of the uniformly charged static latent image 2 is used preferably. In any of the methods, the static latent image to be applied may be either of positive charges or negative charges.

In the developing device 6 of the invention, the conductive particle dispersion solution 7 is brought into contact and supplied to the static latent image 5 formed on the surface of the dielectric thin film 4 to develop and form the conductive pattern with the conductive particles. Accordingly, the developing device 6 has a storage tank for storing the conductive particle dispersion solution 7 and supply means for supplying the same to the static latent image 5 on the dielectric thin film 4. Although not illustrated, concentration detection means for detecting the concentration of the conductive particle dispersion solution 7 is provided in the storage tank. A concentration control means for controlling the concentration by adding a non-polar solvent 15 or a conductive particle 17 (refer to FIG. 2) based on the concentration information obtained from the concentration detection means is provided. Further, the supply means for supplying the conductive particle dispersion solution 7 on the dielectric thin film 4 includes a constitution of forming a layer of the conductive particle dispersion solution 7 on the surface of a rotational roller and bringing the same into contact with the static latent image as shown in FIG. 1. In addition, it also includes a method of blowing the conductive particle dispersion solution 7 by a nozzle or a method of dipping the dielectric thin film 4 formed with the static latent image 5 in a solution storing the conductive particle dispersion solution 7, etc.

Then, the operation of the apparatus in FIG. 1 is to be described.

At first, when the apparatus is started, erasing means (eraser) 10 for erasing the static latent image 5 on the dielectric thin film 4 formed at the surface of the photoreceptor drum is operated and, successively, the conductive particles 17 remaining on the surface are removed by a cleaning device (cleaner) 11. Then, the erasing means 10 is stopped and the cleaning device 11 is spaced apart from the drum surface. Then, the surface of the dielectric thin film 4 is uniformly charged by the charging device 1. Then, the exposure device 3 irradiates light on the uniformly charged dielectric thin film 4 based on image signals sent from an image processing device such as a not illustrated personal computer to form the static latent image 5. Then, by rotating the developing roll provided to the developing device 6 in contact with the photoreceptor drum, conductive particles 17 in the conductive particle dispersion solution 7 are deposited to the static latent image 5 and visualized. The visualized image is transferred by the transfer device 9 to the substrate 8.

The substrate 8 transferred with the image formed by the conductive particles 17 is transported to the heating device 15 in which it is heated to melt the conductive particles and fixed as 14 to the substrate 8. Further, ionic organic molecules deposited on the outside of the conductive particles are evaporized and removed by the heating.

FIG. 2 shows details of the conductive particle dispersion solution 7 of the invention. The conductive particle dispersion solution 7 of the invention comprises conductive particles 17 having a grain size of 100 nm or less in which ionic organic molecules 16 are adsorbed on the surface and dispersed in a non-polar solvent 15. The ionic organic molecules 16 are formed for the function of providing the charges to the conductive particles and preventing agglomeration between the particles.

The ionic organic molecule 16 of the invention includes in a case of high molecular weight molecules, those attached with functional groups capable of providing ionic property such as carboxylic acid groups or amino acid groups to single or mixed polymeric resins such as homo-polymers of styrene and substitutes thereof and copolymers thereof, for example, polystyrene, poly-p-chlorostyrene, polyvinyl toluene, styrene-p-chlorostyrene copolymer, and styrene-vinyl toluene copolymer, copolymers of styrene and acrylate esters, for example, styrene-methyl acrylate copolymer, styrene-ethyl acrylate copolymer, styrene-n-butyl acrylate copolymer, copolymers of styrene and methacrylate esters, for example, styrene-methyl methacrylate copolymer, and styrene-ethyl methacrylate copolymer, styrene-n-butyl methacrylate copolymer, polynary copolymers of styrene, acrylate esters and methacrylate esters, as well as styrenic copolymers of styrene and other vinylic monomers, for example, styrene-acrylonitrile copolymer, styrene-vinyl methyl ether copolymer, styrene-butadiene copolymer, styrene-vinyl methyl ketone copolymer, styrene-maleate ester copolymer, methacrylate ester resins such as polymethyl methacrylate, and polybutyl methacrylate, acrylate ester resin such as polymethyl acrylate, polyethyl acrylate, and polybutyl acrylate, polyester resins, epoxy resin, and cycloolefin copolymer.

Low molecular weight organic molecules include inorganic salts of aliphatic carboxylic acid ions 19 comprising, for example, dicarboxylic acids such as oxalic acid, malonic acid, succinic acid, adipic acid, glutaric acid, 2,4-diethyl glutaric acid, 2,4-diethyl glutaric acid, pimelic acid, azelaic acid, sebacic acid, cyclohexane dicarboxylic acid, malic acid, fumaric acid, diglycilic acid, aliphatic acids such as caprilic acid, lauric acid, myristic acid, palmitic acid, stearic acid, alachidic acid, behenic acid, linolic acid, oleic acid, and linolenic acid, and hydroxyl carboxylic acid such as lactic acid, hydroxyl pivalic acid, dimethylol propionic acid, citric acid, malic acid, glyceric acid and inorganic ions 18 such as Ag, Cu, Au, Pd, Pt, Ni, W, Mo, and Cr. In this case, for decreasing the organic molecule component in the conductive pattern for lowering the resistance and for firing at low temperature for attaining the conductive pattern on a resin substrate such as of polyimide, the latter organic molecule of low molecular weight as shown in FIG. 3 is preferred.

To attain low temperature fusion or high resolution degree, it is necessary that the grain size of the conductive particle 17 of the invention is 100 nm or less and, more preferably, it is 10 nm or less for fusion by heating at 200° C. or lower. Further, to attain a conductive pattern formation with a line width of 100 nm or less, it is preferably, 5 nm or less. The ingredient of the conductive particle 17 includes elemental metals such as Ag, Cu, Au, Pd, Pt, Ni, W, Mo, and Cr, oxides thereof and, further, alloys thereof. For use as the conductive material, use of Ag or Cu with low volumic resistivity is preferred. Further, the conductive particle may be a mixture of plural members described above.

The non-polar solvent 15 of the invention is preferably an aliphatic hydrocarbon solvent and includes isoparaffinic type, organic naphtha type, Isoper H (Exon Co), IP Solvent (Idemitsu Sekiyu Co.), Sortol (Phillips Petroleum Co.), and other hydrocarbons.

Specific examples are to be shown below for the preparation of inorganic fine particle dispersion medium of the invention but they are not particularly restricted to the methods.

Silver stearate (manufactured by Wako Chemical Co., Ltd.) of 3.5 g was charged in special grade guaranteed methanol (manufactured by Wako Chemical Co., Ltd.) of 100 ml, heated under ref lux and completely dissolved. An aqueous solution of silver nitrate formed by charging and dissolving silver nitrate (manufactured by Wako Chemical Co., Ltd.) of 1.5 g in pure water of 25 ml was dropped for 10 minutes. Then, white precipitates were formed in the solution. After completion of the dropping and further stirring under heating for 30 minutes, the apparatus was cooled to a room temperature and when the white precipitated portion was filtered and dried, white silver stearate of 5.0 g was obtained. Then, when the obtained silver stearate of 1.0 g was charged in a furnace and heated at a temperature of 250° C. for 4 hours under nitrogen, a purple solid was obtained. After washing the solid with an alcohol, when it was charged by 100 mg to Isoper H (manufactured by Exon Co.) of 10 mL, irradiated with supersonic waves for 5 minutes and heated to 60° C. for 30 minutes, a blown silver particle dispersion solution in which precipitation was not observed even when it was stood still was obtained. In this case, it was confirmed that the grain size is 10 nm. Further, when a stainless steel electrode plate was dipped in the silver particle dispersion solution and a DC charges at 10 V were applied for one minute at an inter-electrode distance of 1 mm, electrodeposition of the particles on the anode was recognized. Accordingly, it was found that the silver particles in the dispersion medium were charged negatively.

The transfer means 9 for transferring the conductive particle pattern 12 developed on the dielectric thin film 4 onto the substrate 8 by the developing device 6 forming the conductive pattern in the invention is provided. Further, it may be adapted such that the conductive particle pattern formed on the dielectric thin film may be transferred once onto an intermediate transfer body and then transferred to the substrate 8. In this case, it is necessary that the substrate transferred with the conductive pattern has an insulative property.

In the conductive pattern forming apparatus of the invention, heating means 13 is provided for fixing the conductive particle pattern 12 transferred on the substrate 8 to the substrate 8 to form a conductive pattern 14. In this case, the heating means 13 is adapted not only to fuse the conductive particles 17 but also evaporize the ionic organic molecules 16 on the surface of the conductive particles by firing and only the molten conductive particles are left. Further, it may have a function capable of pressing the conductive particle pattern 12 to the substrate 8 simultaneously with heating. In this case, the heating temperature is preferably 300° C. or lower for sufficiently fusing the conductive particles, firing and evaporating the ionic organic molecules, and preventing deformation or denaturation of the substrate 8. In this case, exhaustion means for exhausting evaporized organic ingredients may be disposed.

Other examples are shown below for the conductive pattern formation by heating according to the invention but it is not restricted particularly to the method.

In the present embodiment, a conductive particle pattern of 0.5 mm×8 mm formed on a polyimide was heated by a hot plate at 250° C. for one hour to obtain a conductive pattern of silver of 0.5 mm×8 mm having metal luster on the surface.

In the conductive pattern forming apparatus according to the present embodiment, drying means may be provided for drying and evaporating the solvent component of the conductive pattern after development. Further, the evaporated solvent may be liquefied and returned to the developing device 6, and again recycled as a non-polar solvent 15 for dilution of concentration of the conductive particle dispersion solution 7.

In the conductive pattern forming apparatus of the present invention, the dielectric thin film 4 may be constituted such that a latent image is formed again after transfer of the conductive pattern to develop the conductive particle pattern 12. For the shape, a belt shape or a drum shape is preferred. In this case, it is preferred to provide means (eraser) 10 for erasing residual static latent image on the dielectric thin film, and cleaning means 11 for removing and recovering the residual conductive particles 17. The cleaning means 11 includes a method of scraping by contacting a blade to the dielectric thin film 4, or a method of flushing away by the solvent. Further, the removed and recovered conductive particles 17 may be returned to the developing means 7 and dispersed in the conductive particle dispersion solution 7 again so as to be recycled.

### Second Embodiment

Then, other example of the invention is to be described with reference to FIG. 4A through 4C. In the first embodiment, while the surface of the drum-shaped dielectric body is uniformly charged and light is irradiated thereto to form a static latent image, a second embodiment is a method of using a mask on which a pattern is formed.

As shown in FIG. 4, first, the means for forming the static latent image of the invention brings a mask 20 having an optional pattern in close contact with the surface of the dielectric thin film 4. Then, charging is conducted from above the mask 20 by charging means 1. The surface of the dielectric thin film 4 is charged through openings formed with the pattern. Then, by removing the mask 20, a static latent pattern 5 is formed on the surface of the dielectric thin film 4. In this case, it is preferred that the surface of the dielectric thin film 4 on the side opposite to the charge application surface has a conductive thin film layer 21, and the conductive thin film 21 is in a state grounded to the earth.

While a specific example is shown for the development of the static latent image in this embodiment, this is not particularly restricted to the method.

In this invention, a substrate formed on one side thereof with a polyimide film (45 μm) on a copper foil of 8 μm thickness surface was provided. A metal mask having a pattern of 0.5 mm×8 mm was in close contact on the polyimide film of the substrate, charging was conducted from above the metal mask by a corona charger to obtain a static latent image pattern at a surface potential of about 1000 V. The polyimide substrate having the obtained static latent image was dipped in a conductive particle dispersion solution for one second and then dried spontaneously for 10 minutes to obtain a silver particle agglomeration film of a 0.5 mm×8 mm pattern. Throughout the procedures described above, the copper foil on the surface opposite to the polyimide film was in the state grounded to the earth.

### INDUSTRIAL APPLICABILITY

In the conductive pattern forming apparatus according to the present invention, the formed conductive pattern can be used as substrate wirings, for example, for personal computers, large-scale electronic computers, notebook sized person computers, pen-based personal computers, notebook sized word processors, mobile telephones, mobile cards, wrist watches, cameras, electric shavers, codeless telephones, facsimile units, videos, video cameras, electronic notebooks, electronic calculators, electronic notebooks with communication function, mobile copying machines, liquid crystal television sets, electric tools, cleaners, game machines having functions such as virtual reality, toys, motorized bicycles, healthcare walking aids, healthcare wheeled chairs, healthcare gurneys, escalators, elevators, forklifts, golf carts, emergency power sources, load conditioners, and power storage systems. Further it can be used for household uses, as well as for military and space uses.

### BRIEF DESCRIPTION OF THE DRAWINGS

FIG. 1 is a schematic view of a conductive pattern forming apparatus according to the present invention.

FIG. 2 is a schematic view of a conductive particles dispersion solution according to the present invention.

FIG. 3 is a schematic view of conductive particles having ionic organic molecules with a low molecular weight.

FIG. 4A through 4C are other examples of a conductive patter forming apparatus according to the present invention.

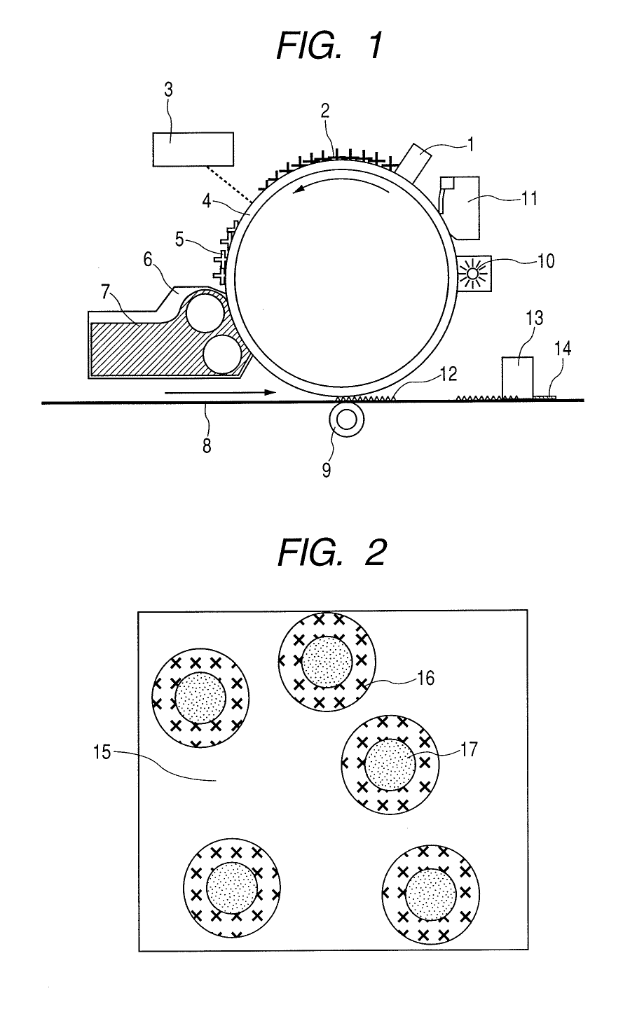

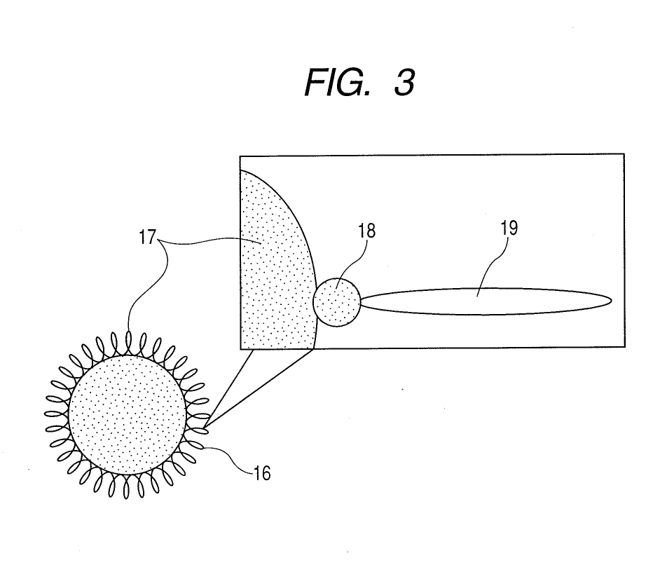

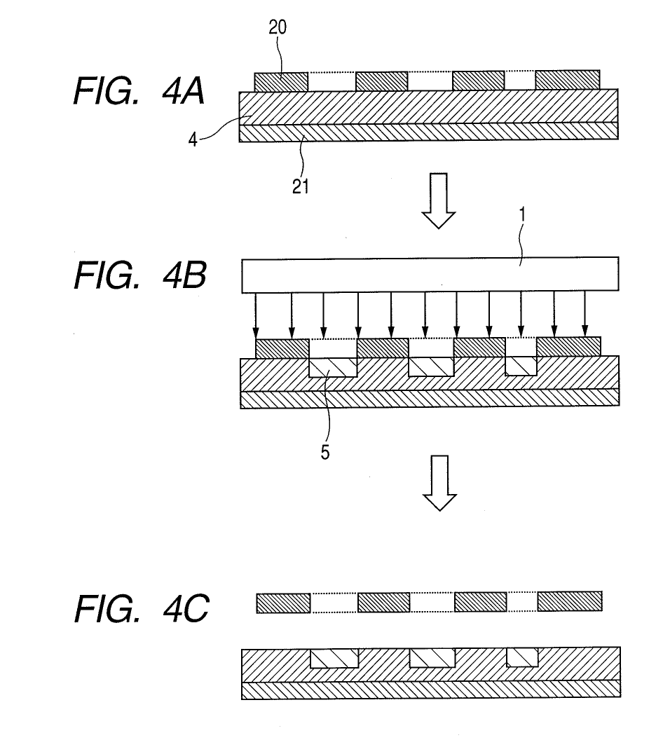

### DESCRIPTION OF NUMERALS

1 charging means
2 static latent image
3 exposure image
4 dielectric thin film
5 static latent image pattern
6 developing means
7 conductive particle dispersion solution
8 substrate
8 transfer means
10 residual latent image erasing device
11 residual conductive particle cleaning device
12 conductive particle pattern
13 heating means
14 conductive pattern
15 non-polar solvent
16 ionic organic molecule
17 conductive particle
18 inorganic ion
19 fatty acid ion
20 mask
21 conductive thin film layer

1. A conductive pattern forming apparatus, comprising:
means for forming a static latent image on the surface of a dielectric thin film; and
means for supplying a conductive particle dispersion solution and bringing the conductive particle dispersion solution into contact with the static latent image and developing the static latent image with conductive particles;
wherein the conductive particle dispersion solution is formed by dispersing a conductive particle with a grain size of 100 nm or less having ionic organic molecules adsorbed on the surface in a non-polar solvent.

2. The conductive pattern forming apparatus according to claim 1, further comprising:
means for transferring a conductive pattern formed on the surface of the dielectric thin film to a conductive pattern forming substrate.

3. The conductive pattern forming apparatus according to claim 1, further comprising:
means for transferring a conductive pattern on an intermediate transfer body; and
means for transferring the conductive pattern transferred on the intermediate transfer body onto the conductive pattern forming substrate.

4. The conductive pattern forming apparatus according to claim 2 or 3, further comprising:
means for heating or pressurizing the conductive pattern transferred on the substrate.

5. The conductive pattern forming apparatus according to claim 1, wherein
the static latent image forming means includes a dielectric thin film formed of a photosensitive material that is a constituent material and that loses surface charges of the irradiated portion by the photo-irradiation, a static charge applying means for forming a static charge on the surface of the dielectric thin film, and an exposure means for irradiating light to the static charge on the surface of the dielectric thin film thereby forming a static latent image pattern.

6. The conductive pattern forming apparatus according to claim 1, wherein
the dielectric thin film has a photosensitivity, and the apparatus has a charging means for uniformly charging the surface of the dielectric thin film, and an exposure means for irradiating light on an optional portion on the surface of the uniformly charged dielectric thin film.
